(19) United States
(12) Patent Application Publication
(10) Pub. No.: US 2003/0206686 A1
(43) Pub. Date: Nov. 6, 2003

(54) Method and apparatus for improving beam power

(76) Inventors: Stanley Pau, Hoboken, NJ (US); Alan Weiss, Millburn, NJ (US); Carl J. Nuzman, Summit, NJ (US)

Correspondence Address: HARNESS, DICKEY & PIERCE, P.L.C., P.O. BOX 8910, RESTON, VA, 20195, US

(21) Appl. No.: 10/137,292

(22) Filed: May 3, 2002

(51) Int. Cl. G02B 6/35

(52) U.S. Cl. 385/18

(57) ABSTRACT

An algorithm for improving signals between two or more mirrors is described. The algorithm is used to determine the initial voltages for improved signal transmission and is also used to maintain improved transmission. The algorithm utilizes random jump when the signal is too low. The step sizes and bounding boxes for the algorithm can be determined from modeling. One by-product of the algorithm is the determination of the hill shape. This information can be used in a subsequent accelerated retraining procedure. An a priori quadratic approximation of the hill's shape is used to reduce the number of measurements used for retraining.

### TECHNICAL FIELD

The present invention relates to the field of improving beam power.

### BACKGROUND ART

An optical cross-connect connects signals from a set of input fibers to a set of output fibers in an arbitrary one-to-one arrangement, essentially functioning as a crossbar switch. An optical cross-connect 100 may accomplish this function via a pair of mirror arrays 102, 104, as illustrated in FIG. 1. Each fiber 106 in a set of input fibers is aligned with its own input mirror in input mirror array 102 and each fiber 108 in the set of output fibers is aligned with its own output mirror in the output mirror array 104. Microlens 110 and field lens 112 may or may not be present. The input mirror array 102 and/or the output mirror array 104 may be fabricated on a single, separate silicon chip. Each input mirror of input mirror array 102 and each output mirror of array 104 is typically free to swivel through a range of ±5°. Each mirror of input mirror array 102 and each output mirror of output mirror array 104 may be approximately 100-500 microns across, may be shaped as square, circular or elliptical, and may be gimbaled with the tilt angle being selectively determined by the amount of voltage applied to one or more control electrodes.

Gimbaled mirrors are capable of operatively rotating or tilting about at least two axes, for example, orthogonal X-Y axes of rotation. With two axes, one axis is termed the mirror axis, the other axis (typically orthogonal to the mirror axis) is the gimbaled axis. Gimbaled mirror configurations are described in U.S. Pat. No. 6,201,631 to Greywall. Other mirrors, with only one axis, are also known in the art. The angle of each input and output mirror of input mirror array 102 and output mirror array 104 is adjusted by applying a voltage to the one or more electrodes located close to each mirror.

In order for a beam of light to pass from input fiber 106 to output fiber 108, the input mirror associated with input fiber 106 must direct the beam of light to an output mirror associated with output fiber 108, which must in turn direct the beam of light to output fiber 108.

Under ideal conditions, the voltages required to send light from each input fiber to each output fiber could be measured, cataloged in a voltage database, and used for every optical cross-connect, which is manufactured. However, manufacturing imperfections and other hard-to-reproduce conditions require a unique database of voltages for each individual optical cross-connect. The hard-to-reproduce conditions may include noisy measurements, drift, and steady-state variations. The process of determining the voltages for an optimized signal transmission is called training. For an optical cross-connect with 256 input fibers and 256 output fibers, training requires (256)²=65536 separate optimizations.

The time required to train a single input-output pair depends on many factors. The most important factor is the time required for a mirror (input and output) to change from one field position to another. In one implementation, this time has been measured to be about 10 ms. A reasonable training run including 500 measurements would thus require 5 seconds per input-output fiber pair, and therefore almost almost four days to train a single optical cross-connect. Further, next generation optical cross-connects will have 1296 or more inputs with perhaps the same number of outputs, leading to 1,679,616 or more input-output fiber pairs to train. At 5 seconds per training pair, it would take over three months to completely train one 1296 input×1296 output optical cross-connect. Thus, one problem with conventional optical cross-connect training techniques is that they require too many measurements and are therefore, much too time-consuming.

A conventional method of training an optical cross-connect includes two procedures: coarse training and fine training. For coarse training, a high-speed IR camera may be aimed at the output mirror array 104 while an input signal is sent on the input fiber 106. The camera can see the spot of light on the output mirror array 104, and the input mirror of input mirror array 102 which corresponding to input fiber 106 is rotated so that the spot is roughly centered on the desired output mirror of the output mirror array 104. This procedure is repeated for each input mirror of the input mirror array 102.

Similarly, the camera is aimed at each input mirror of the input mirror array 102, while light is shone through output fiber 108. The output mirror is rotated so as to center the light on the desired input mirror of the input mirror array 102. This procedure is repeated for each output mirror of the output mirror array 104 and a rough database of voltages is generated to establish each possible connection. This process can be automated, with computers controlling the various voltages and steering the spot of light to the various input and/or output mirrors.

For fine training, initially the light from input fiber 106 is directed to output fiber 108, using the voltages in the coarse training database, and received power is measured at the output fiber 108. Then the input and output mirrors, corresponding to input fiber 106 and output fiber 108, are adjusted, while received power is measured, to attempt to maximize the measured power. Once the signal is deemed sufficiently strong, the final voltages are stored in a database so that the connection may be reestablished whenever desired. The process of fine-training mirrors by trying to maximize received power is called “hill climbing”. There are many conventional algorithms for hill climbing, however in view of the number of measurements which are required, none of the conventional algorithms are fast enough or converge quickly enough.

After training, an optical cross-connect is shipped to a customer, where it is put into use. One problem is that the training database might not be accurate, or that it may, in time, become inaccurate. There are two conventional techniques for adapting the database of connection voltages in the field. One is to periodically sample existing connections, and try to optimize received power. This is called slow dither. The other technique is used when a connection is first attempted. If the resulting power is too low for a successful connection, then a search is performed in order to make a good connection. This is called fast dither.

### SUMMARY OF THE INVENTION

In at least one embodiment, the present invention is directed to a method and apparatus for performing fast dither which performs a hill climbing algorithm to obtain a suitable number of points of sufficient power to define the shape of a hill from which a point of sufficient (or even maximum) power, may be selected. The point of sufficient (or even maximum) power is used to make a connection between a specific input-output mirror pair of the optical cross-connect.

In conjunction with the hill climbing algorithm, in at least an embodiment a random jump is implemented (within a bounding box of interest) to ensure the hill climbing routine does not settle on a local maximum. In attempting to find a point of sufficient (or even maximum) power, a fast dithering algorithm may find a local, not a global maximum. If such an undesirable local maximum is found, a random jump is an effective way to essentially restart the fast dithering algorithm to enable the global maximum to be found.

In at least one embodiment, the present invention is directed to a method and apparatus for performing fast dither which implements a robust algorithm, such as the Nelder-Mead algorithm, in combination with a quadratic optimization algorithm to obtain the suitable number of points of sufficient power to define the shape of the hill from which a point of sufficient (or even maximum) power, may be selected.

In at least one embodiment, the robust algorithm includes generating a simplex around a point of interest, climbing a given number of steps, determining whether enough good points are present, and determining whether the power is improving. In at least one embodiment, the step sizes in the robust algorithm are proportional to the size of the bounding box.

In at least one other embodiment, the quadratic optimization algorithm includes choosing a set of highest power points and performing a quadratic fit, climbing a given number of steps, determining whether the best power has changed, and if so, discarding the lowest power point in favor of the new point. If many steps are taken, the set of data points in the Nelder-Mead algorithm and/or the quadratic fitting algorithm may become singular, or nearly so, if the points lie on a non-unique quadratic, such as a straight line or circle. Essentially the set of points loses “poisedness”. This can be corrected by periodically taking a poisedness step to ensure the modified set of highest power points still resembles a set of data points to which a quadratic may be fit.[extra period} After one or more iterations, the quadratic optimization algorithm will produce a point of sufficient (or even maximum) power.

In at least one other embodiment, the present invention is directed to a method and apparatus for performing slow dither which uses a known hill shape and a set (usually a small set) of measurements to find the top of the hill, which is the point where sufficient (or even maximum) power is transmitted.

### BRIEF DESCRIPTION OF THE DRAWINGS

FIG. 1 illustrates a conventional optical cross-connect.

FIG. 2 illustrates a flowchart of fast dither in one exemplary embodiment of the present invention.

FIGS. 3(a) and 3(b) illustrate the voltages required for a typical input mirror to reach each of 256 output mirrors in an output mirror array.

FIGS. 4(a), 4(b) and 4(c) illustrates a flowchart of the algorithm used to train and/or dither mirrors in one exemplary embodiment of the present invention.

FIGS. 5(a) and 5(b) shows two views of a hill to be climbed by the hill-climbing routine of the present invention.

### DETAILED DESCRIPTION

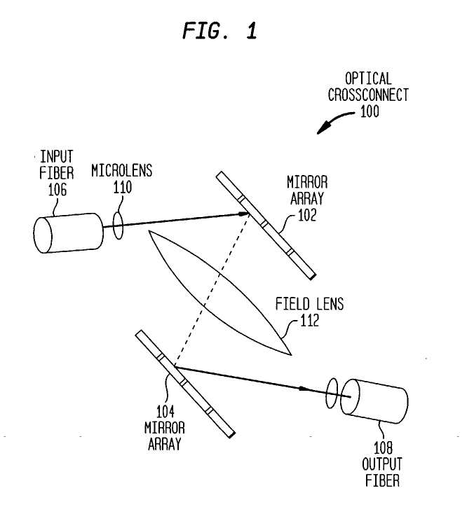

In order to align two elements, such as mirror arrays 102 and 104 in FIG. 1, there first may be an initial setting which is utilized in order to direct a signal from each input mirror of input mirror array 102 to each output mirror of output mirror array 104 and vice versa. This initial setting is usually obtained via training. Each of the input and output mirror elements of the input mirror array 102 and output mirror array 104 could be measured. Alternatively, a subset of mirror pairs can be measured and the rest can be interpolated.

It is known that regularities exist in the pattern of voltages needed to establish connections, as a function of mirror position. Therefore, a subset of the mirrors can be trained, and those voltages can be used to infer the voltages for other mirrors close by.

The measured and/or interpolated values are used to produce a training database, which is then used as a first guess for determining the strength of a signal from each input mirror to each output mirror. The result is that a signal is propagated from a given input mirror in the input mirror array 102 to an output mirror in the output mirror array 104 and that signal is received on output fiber 108. However, the magnitude of that signal is not as high as it could be because the original guess from the training database are most likely in error due to drift and other errors.

Now that a signal is actually being received on output fiber 108, the goal is to improve the quality of the signal being received at the output fiber 108. Essentially, this is a search to position each input/output mirror pair such that a maximum strength signal is received on the corresponding output fiber 108. This task is complicated by the fact that each optical cross connect of each mirror pair is different. Further, even for the same input/output mirror pair of the same optical cross connect, the maximum strength signal vary over time and be affected by noise. Still further, the determination of the optimum magnitude may be made more difficult by the presence of sub-peaks. Essentially, dithering is an efficient way to climb to the top of a hill. In the present invention, fast dither include a robust search first using an algorithm such as the Nelder-Mead algorithm. Once the signal strength value is near the top of the hill, a quadratic search, such as an accelerated quadratic technique is used to further refine the location of the top of the hill.

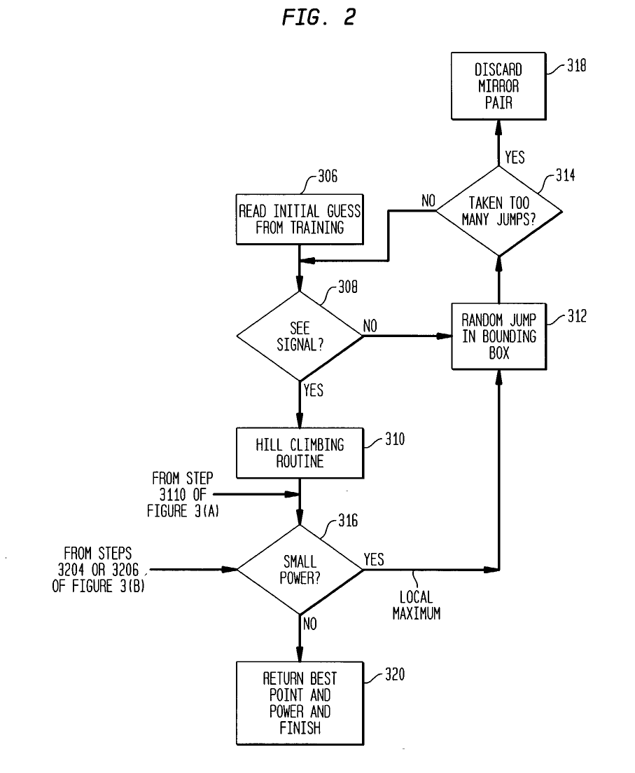

FIG. 2 is a flowchart illustrating the processing steps performed during fast dither. Initially, in step 306, an initial guess is read from a training database obtained during training. In step 308, it is determined whether the signal has reached the output element from the input element. If yes, the processing proceeds to a hill climbing routine 310, which is used to find a point of increased or maximum power, and which will be described in more detail below.

The first step in implementing a fast dithering method is to develop an appropriate algorithm. Two known algorithms, the Nelder-Mead algorithm (LRWW) and Powell's algorithm, which are described in “Numerical Recipes in FORTRAN 77: The Art of Scientific Computing”, Cambridge University Press, 1986-1992, pp.402 et seq. are robust and fast enough to be candidates for fast dither.

One exemplary criterion for a candidate algorithm is the average number of iterations to reach the peak from a random position for a fixed percentage below the peak. One set of experiments shows that, on the average, the Nelder-Mead algorithm can reach a peak from 30 db below the maximum within 100 iterations, whereas Powell's algorithm requires more than 300 iterations on the average. It is also noted that, in general, the Nelder-Mead algorithm is less susceptible to fluctuations in power and can converge to the peak even when the peak and the shape of the hill are slowly changing with time.

The number of iterations to reach the peak is sensitive to the initial step size. The initial step size is a function of the location of the mirror and of the particular device characteristics of the mirror. An appropriate step size using interpolation can be estimated as follows.

Because the mirrors are regularly spaced, the width of the power hill, in voltage space, is proportional to the derivative of the interpolation function in the vicinity of that mirror. The interpolation function describes the voltage and beam position relationship for each mirror. Therefore, if the size of a step for one mirror is known, the step for all other mirrors can be inferred. In practice, the initial step size may also be calculated from the training database. The voltage difference between neighboring mirrors is approximated and used to set a scale.

The Nelder-Mead algorithm has a tendency to degenerate after several iterations. Furthermore, the hill may have multiple local maxima, which the algorithm must escape from. This is achieved by monitoring the history of the hill climbing for each connection. Therefore, the algorithm of the present invention resets the values for the simplex when the simplex becomes degenerate. The algorithm of the present invention also identifies the local maxima and goes into a random jump mode in four dimensional voltage space. A local maximum is reached when the changes of consecutive measurements are small and when the intensity stays below a predetermined value. In the random jump mode, the algorithm of the present invention sets the voltages to be random values within a fixed range. The random jump ends when a signal is found or when the maximum number of iteration is reached. The range of voltage for the random jump is determined by the voltages for reaching the neighboring mirrors and can be set proportional to the initial voltage step sizes. In one embodiment, the proportionality constant is set to be 10.

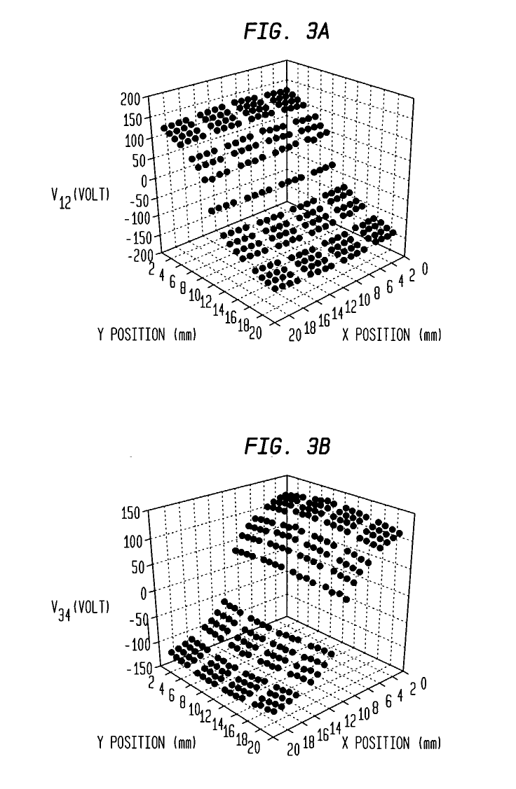

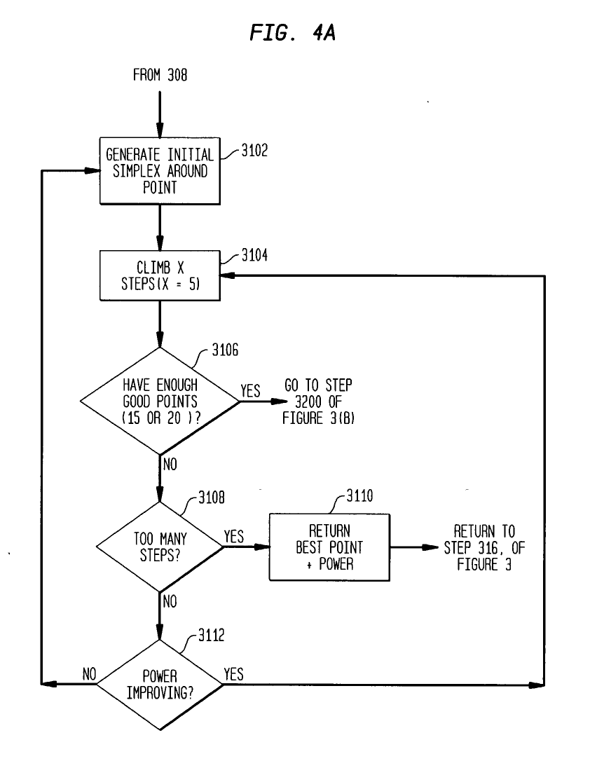

There are some physical processes that become apparent during dithering. One of these is drift—after setting a voltage, the input and/or output mirrors slowly move, and a new voltage is needed to maintain high power. This effect may be attributed to charging of the electrodes. Another effect is hysteresis. This means that hill climbing is dependent on the exact sequence of steps used, not just on the final voltage. This means that the patterns shown in FIGS. 3(a) and 3(b) could depend on the history of how voltages were set. In practice, mirrors that have excessive drifting or hysteresis are identified, marked as bad, and not used.

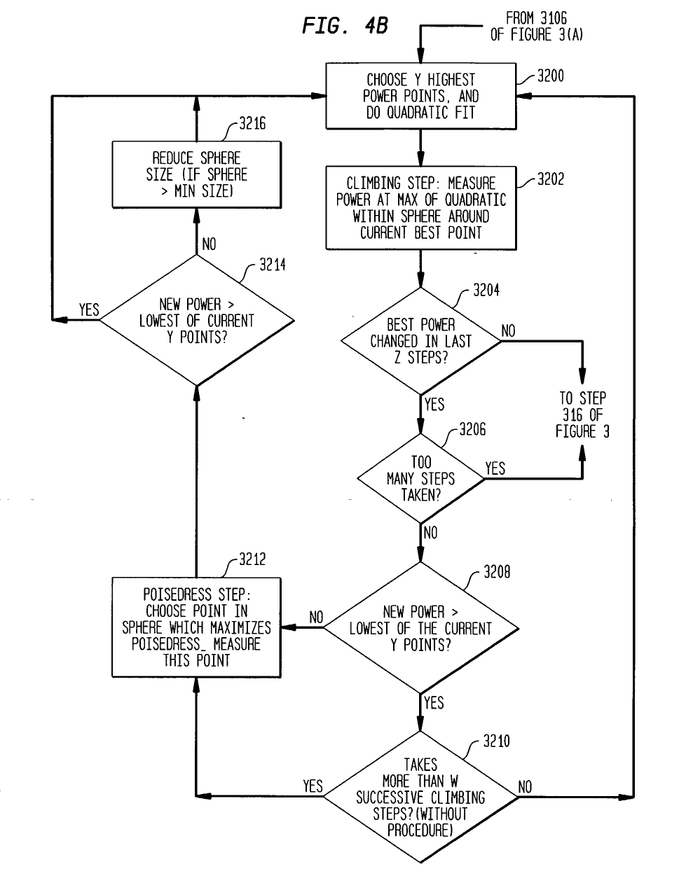

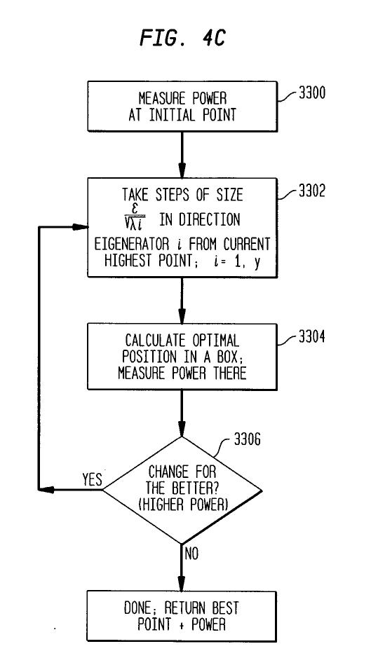

In step 316, the power is measured, if the power is sufficient, the processing returns the best point and power in step 320 and completes. If an unacceptably low power is measured in step 316, processing proceeds to step 312, where a random jump is performed in a bounding box 312. Flow also proceeds to step 312 if a signal is not seen at all in step 308. The size of the bounding box in 312 (and the step side discussed below in conjunction with FIGS. 4(a)-4(c)) may be determined by interpolation or measurement. Once a random jump is taken in step 312, the processing proceeds to step 314 in order to determine whether too many jumps have been taken. If not, processing proceeds to step 308 to again determine whether a signal can be seen at the output element. If too many jumps have been taken at step 314, processing proceeds to step 318 to discard that particular input/output mirror pair.

The hill climbing routine 310 of FIG. 2 is further described in conjunction with FIGS. 4(a) and 4(b) below. The hill climbing routine 310 includes at least two steps, the first of which is illustrated in FIG. 4(a).

Step 3102 of FIG. 4(a) receives the output from step 308 of FIG. 2. In step 3102, an initial simplex is generated around the current point to obtain a group of points. In step 3104, the hill is climbed, using x steps (where in a preferred embodiment, x=5). If the resulting processing results in enough good points in step 3106, (wherein enough good points in a preferred embodiment is 15 or 20), processing proceeds to a quadratic climb illustrated in more detail in FIG. 4(b). If enough good points are not obtained in step 3106, processing proceeds to step 3108 which determines whether too many steps have been taken. If too many steps have been taken, processing proceeds to step 3110 which returns the best point and power. Processing then proceeds to step 316 in FIG. 2.

If too many steps have not been taken, a determination is made in step 3112 as to whether the power is improving. If not, processing returns to step 3102 to generate a new simplex around the point. If the power is improving, processing proceeds to step 3104 to continue climbing up the hill. In a preferred embodiment, the algorithm used to implement FIG. 4(a) is the Nelder-Mead algorithm. Alternatively, the Powell algorithm or other similar algorithm could also be used.

If enough good points have been produced in step 3106 of FIG. 4(a), processing proceeds to the quadratic climb illustrated in FIG. 4(b).

The hill-climbing routine of step 310, in one exemplary embodiment of the present invention, also implements a novel quadratic optimization algorithm for hill climbing. The novel quadratic optimization algorithm for hill climbing, in one exemplary embodiment of the present invention, is a modified version of the Conn, Scheinberg, Toint (CST) algorithm described in “Recent Progress in Unconstrained Nonlinear Optimization Without Derivatives”, ISMP97, Lausanne, August 1997 and is described in more detail below.

The logarithm of measured power is considered the height of a hill (in four dimensions, the dimensions being the two voltages for the input mirrors and the two for the output mirrors). Any smooth hill should be well-approximated by a quadratic function near its top. The idea behind the algorithm, in one exemplary embodiment of the present invention, is to try to approximate the hill by a quadratic function, and thus be able to pinpoint the location of the top. With the quadratic fitting method of the present invention, very fast convergence is possible, because the quadratic fitting method of the present invention uses a fitted function to determine where the top is likely to be, and proceeds to that point.

The logarithm of power is chosen, rather than the measured power itself, for two reasons. First, a beam has a roughly Gaussian cross section, so the logarithm should look quadratic. Second, and even more importantly, taking a logarithm tends to smooth out peaks, making the quadratic fit more robust.

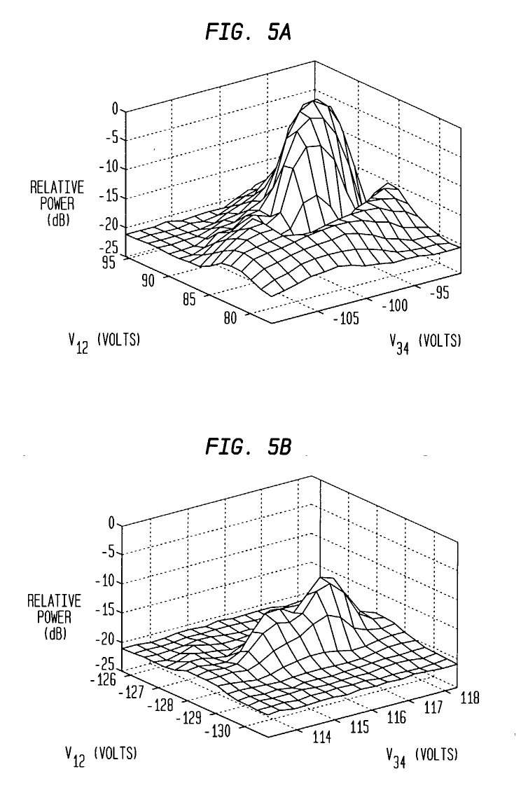

The hills at issue in the present invention are rather complicated. FIGS. 5(a) and 5(b) shows two views of a hill. It is difficult to visualize a hill in four dimensions, so FIGS. 5(a) and 5(b) show two slices of the same hill. FIG. 5(a) has fixed voltages on the output mirrors, and shows the relationship between the logarithm of measured power as output mirror voltages change. FIG. 5(b) has fixed output voltages, and shows the response to varying input voltages. FIGS. 5(a) and 5(b) shows clearly that the hill is not very well-modeled by a quadratic function away from the peak. It is also noted that neither the slice shown in FIG. 5(a) or 5(b) goes through the peak of the function.

There is at least one difficulty with using a fitted function in more than one dimension that are related to the geometry of the points chosen for fitting. This difficulty has been termed “well-poisedness”. A set of points may be well- or ill-poised, depending on whether or not there is a unique quadratic polynomial that passes through them.

For the purpose of the optical cross-connect, in one exemplary embodiment of the present invention, it is assumed that it takes at least 15 points (this number is exemplary and other numbers of points could be used as would be known to one of ordinary skill in the art) to determine a quadratic polynomial. Specifically, if x=(x₁,x₂ x₃,x₄)^{t} is a column vector of the four nonzero voltages under consideration (a^{t} represents the transpose of a vector a) and y represents the logarithm of measured power when the voltages are set to x. Then the quadratic fit is given by a real symmetric matrix Q, a column vector d, and a real number c, by the equation

$$y = \frac{1}{2} {χ}^{t} Q χ + {d}^{t} x + c . \qquad ( 1 )$$

Since Q is a symmetric four-by-four matrix, there are ten parameters in it; d has four parameters; and c has one parameter; therefore, there are 15 parameters to fit. If 15 values of x are chosen, and the resulting power is measured at those points, there still may not be a unique quadratic that fits the measurements. For example, if all the points are on a line, then there are many quadratics that fit. A less obvious example is if all the points are on a circle; many quadratics have the same circle as a level set, so there is no uniqueness. The problem of well-poisedness is exactly the problem of unique solvability for the function in Eq.(1) with 15 measurements of y at 15 different values of x.

There is another problem with fitting a quadratic function to measurements. Measurements have noise. Fitting a quadratic to a noisy data set might lead to inaccuracies.

The considerations of noise and poisedness leads us to the following algorithm. After the Nelder-Mead (or other similar) algorithm has found a place where a good number of measurements were above some threshold, a four-dimensional quadratic function is fit to the logarithm of the signal strength. In one exemplary embodiment of the present invention, 20 measurements are taken and a simple least-squares fit of the points. is chosen. In another exemplary embodiment of the present invention, no less than 15 measurements are taken.

In step 3200, a select number, y of highest power points are chosen and a quadratic fit is performed. Initially, it may be preferable to take a few as ten measurements and there may be no unique quadratic for these measurements. However, taking a pseudo-inverse, a quadratic having a set of coefficients of small norm can work very well. As more points are measured, more points can be added to the quadratic, up to around 20, in at least one preferred embodiment. In step 3202, a climbing step is performed, where power is measured at the maximum of the quadratic within a sphere around the current best point. In one embodiment of the present invention, two mirrors (input and output) in two dimensions (two degrees of freedom) are used. This results in a four dimensional search including 15 variables.

In step 3204, a determination is made as to whether the best power has changed in the last z steps. In a preferred embodiment, z=5.

If the best power has changed in the last y step, processing proceeds to step 3206 to determine whether too many steps have been taken. If the answer is yes in step 3206 (and no in step 3204), processing returns to step 316 in FIG. 2. If too many steps have not been taken in step 3206, processing proceeds to step 3208 where a determination is made as to whether the new power is greater than the lowest of the current number of selected points. If yes, in step 3210, a determination is made as to whether more than w successive climbing steps have been taken without a “poisedness” correction. If so, the set of points may become singular, where no unique quadratic exists; this is termed “unpoised”. The “poisedness” of the data points may be corrected periodically and the quadratic refit. This correction may be performed every 5 or 10 iterations, for example. In the preferred embodiment, w=8.

If a poisedness step has been taken recently, processing returns to step 3200 to choose the new y highest points and recalculate the quadratic fit. If a poisedness step has not been taken recently, processing proceeds to step 3212, to perform a poisedness step. Processing also proceeds to step 3212 if the new power in step 3208 is less than the lowest of the current y points. In the poisedness step of step 3212, a point is chosen in the sphere which maximizes poisedness and a power measurement is taken at this point. In step 3214, a determination similar to step 3208 is taken, namely whether the new power is greater than the lowest of the current y points. If yes, processing returns to step 3200. If no, processing proceeds to step 3216, where the sphere size is reduced if the sphere size is greater than a minimum sphere size. Once step 3216 has been performed, processing returns to 3200. It is noted that the size of the sphere, may also be determined by interpolation or measurement.

The output of flowchart FIGS. 2, 4(a), and 4(b) produces the maximum power point of the hill as well as the hill shape. Processing can then proceed to slow dither, an exemplary flowchart of which is illustrated in FIG. 4(c). It is noted that in the slow dither processing of FIG. 4(c), knowledge of the hill shape is required. As discussed above, the hill shape can be supplied by fast dither. Alternatively, the hill shape may be supplied from a training database or by hill shape interpolation.

It is assumed that drift may occur during the operation of an optical cross-connect, causing measured power to drop. There are many possible causes for drift. Drift may manifest itself in a movement of the position of the quadratic response function, which is assumed keeps its shape. That is, suppose the response function (power y versus voltages X=(x₁, x₂, x₃, x₄)^{t}) near its peak is represented as

$$y = \frac{1}{2} {( X - α )}^{t} Q ( X - α ) + c , \qquad ( 2 )$$

where a is a vector of offset voltages, and c is the maximum power.

Then it is assumed that Q does not change with time, but that a and c might. If this assumption is correct, then it is possible to use knowledge of Q to reduce the number of measurements required for dithering.

In order to maximize measured power y, in one exemplary embodiment of the present invention, current power yₒ at the current (base) position Xₒ is measured with the current offsets a and c as unknowns. Then a step is taken proportional to the inverse square root of an eigenvalue of Q in the direction of its corresponding eigenvector. This position is called position X₁. If the measured power y₁>yₒ then set X₁ as the new base; otherwise, Xₒ remains the base. Then steps are taken in directions of the other eigenvectors in turn from the current base, proportional to the inverse of the square root of the eigenvalue size, power is measured, and the base may be reset if the power is larger than that at the previous base. This gives a set of measurements y₁, i=0,1,2,3,4, taken at positions Xᵢ. These measurements are enough to uniquely determine a and c. Then a measurement at X=a should confirm that this point yields the maximum power. The above-described procedure thus takes six measurements to calculate the optimal setting of voltages under ideal conditions. When Q is known exactly, or when measurement noise is significant, overfitting a and c should provide excellent performance with few additional measurements.

Writing Eq. (2) in diagonalized form, assuming all the eigenvalues are negative,

$$y = {\sum }_{i = 1}^{4} - \frac{{λ}_{i}}{2} {( {χ}_{i} - {α}_{i} )}^{2} + c , \qquad ( 3 )$$

where the λᵢ represent the magnitudes of the eigenvalues of Q, and the xᵢ are the components of X. In these coordinates, the coordinate directions are the eigenvectors. Suppose that each step is given by ε\sqrt{λᵢ}; this is just to define the constant of proportionality Ε. The first two measurements that the algorithm defines are

$$\begin{matrix}yo = {\sum }_{i = 1}^{4} - \frac{{λ}_{1}}{2} {( {χ}_{o , i} - {α}_{i} )}^{2} + c & ( 4 ) \\ y1 = - \frac{λ1}{2} {( {χ}_{o , 1} - {α}_{1} + \frac{ϵ}{\sqrt{{λ}_{1}}} )}^{2} - {\sum }_{i = 2}^{4} \frac{{λ}_{i}}{2} {( {χ}_{o , i} - {α}_{1} )}^{2} + c , & ( 5 )\end{matrix}$$

where the components of Xₒ are denoted X_{o,i}. Subtracting the two equations gives

$$\begin{matrix}y1 - yo = - \frac{{λ}_{1}}{2} ( {( {χ}_{0 , 1} - {α}_{1} + \frac{ϵ}{\sqrt{{λ}_{1}}} )}^{2} - {( {χ}_{o , 1} - {α}_{1} )}^{2} ) = - & ( 6 ) \\ \sqrt{{λ}_{1}} ϵ ( {χ}_{o , i} - {α}_{1} ) - \frac{{ϵ}^{2}}{2} \\ so that & ( 7 ) \\ {χ}_{o , 1} - {α}_{1} = \frac{y1 - y0 + \frac{{ϵ}^{2}}{2}}{- ϵ \sqrt{{λ}_{1}}} . & [ 8 ]\end{matrix}$$

This means that the high point of the hill comes when xᵢ is set to

$${χ}_{o , 1} + \frac{y1 - y0 + \frac{{ϵ}^{2}}{2}}{ϵ \sqrt{{λ}_{1}}} . \qquad [ 9 ]$$

Assuming that y₁>yₒ, the third point measured is

$$y2 = - \frac{{λ}_{1}}{2} {( {χ}_{0 , 1} - {α}_{1} + \frac{ϵ}{\sqrt{{λ}_{1}}} )}^{2} - \frac{{λ}_{2}}{2} {( {χ}_{0 , 2} - {α}_{2} + \frac{ϵ}{\sqrt{{λ}_{2}}} )}^{2} - {\sum }_{i = 3}^{4} \frac{{λ}_{i}}{2} {( {χ}_{o , i} - {α}_{i} )}^{2} c . \qquad [ 10 ]$$

Again, subtracting the equations for y2 and y1 gives

$${χ}_{o , 2} - {α}_{2} = \frac{{y}_{2} - {y}_{1} + \frac{{ϵ}^{2}}{2}}{- ϵ \sqrt{{λ}_{2}}} . \qquad [ 11 ]$$

It is clear that the next measurement gives x_{0,3}−a₃, and the final measurement gives x_{0,4}−a₄. The value of c may then be inferred from Eq. (4). Maximum power is given by setting all voltages so that xᵢ−aᵢ=0. In embodiment of the present invention, after setting these voltages, a final measurement may be taken. Clearly, if the power does not improve at this step, then the model is faulty, and an alternate hill-climbing algorithm should be used.

If the point Xₒ is far from the maximum point, then the algorithm might not cause the final step to reach the maximum point. This is easily understandable, since the hill may not be well-modeled by a simple quadratic far from the maximum point; this is depicted clearly in FIGS. 5(a) and 5(b). In this case, continuing the algorithm can lead to a quick location of the maximum in many cases. A poisedness step may be taken periodically (for example, every three to five measurements) and oversampling the function by keeping the most recent seven measurements should reduce the effects of noise.

The processing of slow dither is described in conjunction with FIG. 4(c). In step 3300, an initial measurement is taken; this corresponds to Eq. (4). In step 3302, the four steps are taken iteratively, with corresponding measurements. The first corresponds to Eq. (5). In words, a step and measurement taken in one eigendirection, with step size proportional to the inverse square root of the magnitude of the corresponding eigenvalue. At each step, the base position (for performing further steps) is set to the point having higher power (at the beginning or end of the step). This is shown, for example, in Eq. (10). After the four steps of 3302 are taken, then, in step 3304, using Eqs. (9) or (11) as examples, the top of the hill can be calculated, and a power measurement is taken there. If the power in step 3304 is sufficiently higher than the highest power in step 3302, then the algorithm returns to step 3302 to try to increase the power further. If not, then a decision is made whether the power is high enough. If the power is high enough, the algorithm exits with the best power and position; if not, then the algorithm returns to fast dither.

For storing and utilizing Q, it is more efficient to store the eigenvectors and eigenvalues instead of Q itself. The four eigenvalues are arbitrary real numbers and should all be negative. The eigenvectors can be stored efficiently as a set of three Householder matrices, containing 3, 2, and 1 parameters, for a total of six real numbers. Therefore, the original Q matrix, itself having ten real numbers, from which, in principle, its eigenvalues and eigenvectors may be derived, can be represented in a compact way by ten other numbers that directly encode its eigenvalues and eigenvectors. The eigenvalues and eigenvectors are used directly in the algorithm for optimizing power, so this is computationally efficient.

In practice, the hill shape, described by the Q matrix, are determined after each dithering process. In situations where the hill shape is not available or when the original database becomes inaccurate, interpolation can be used to determine the hill shape.

The sensitivity of received power to changes in mirror voltages, that is, the shape of the hill, varies greatly from one connection to another. Most of the variation in hill shape is due to variability in the mapping from mirror voltage to mirror angle. This effect can be measured and predicted using an interpolation function.

Although one or more of the exemplary embodiments of the present invention have been described in the context of an optical cross-connect, the concepts of the present invention are also applicable to other optical assemblies, such as dynamic gain equalizers, wave cross-connects, etc. Further, although one or more of the exemplary embodiments of the present invention have been described in the context of mirrors, the concepts of the present invention are also applicable to other elements. Still, further, although one or more of the exemplary embodiments of the present invention have been described in the context of an optical medium, the concepts of the present invention are also applicable to other media, such as microwave, x-ray, sound, laser, etc.

Although one or more of the exemplary embodiments of the present invention have been described in the context of using a simplex algorithm, such as the Nelder-Mead algorithm, in combination with a random jump in a bounding box and a quadratic optimization, any subset of these features could also be implemented to improve the performance of an assembly.

Although the various embodiments of the present invention have been described in the context of fiber optics, the present invention also contemplates other media, for example, free space optics, light, microwaves, sound, or other signals in general.

What is claimed:

1. A method of training an assembly having at least one input mirror and at least one output mirror, comprising:
directing a signal through the assembly;
measuring at least one of an actual signal input to the assembly and an actual signal output from the assembly as a function of position of the at least one input mirror and the at least one output mirror; and
searching for an improved signal output as a function of position of the at least one input mirror and the at least one output mirror including,
performing a hill climbing algorithm to obtain a suitable number of points of sufficient signal power to define a shape of a hill and to identify a point from the suitable number of points of sufficient signal power,
implementing a random jump within a bounding box of interest to ensure the hill climbing algorithm does not settle on a local maximum,
selecting the point from the suitable number of points of sufficient signal power, and
determining operating conditions for the optical cross-connect that correspond to the suitable number of points of sufficient signal power and using operating conditions that correspond to the selected point to make an improved connection between the at least one input mirror and the at least one output mirror of the assembly.

2. The method of claim 1, said hill climbing algorithm further including,
performing a robust algorithm to obtain the suitable number of points of sufficient power to define the shape of the hill, and
performing a quadratic optimization algorithm to identify the point from the suitable number of points of sufficient power.

3. The method of claim 2, wherein said robust algorithm further includes,
generating a simplex around a point of interest,
climbing a given number of steps,
determining whether enough usable points are present, and
determining whether the power is improving.

4. The method of claim 3, wherein a size of the steps is determined by implementing a random jump within the bounding box of interest.

5. The method of claim 2, wherein said robust algorithm is the Nelder-Mead algorithm.

6. The method of claim 2, wherein said quadratic optimization algorithm includes,
choosing a set of highest power points and performing a quadratic fit,
climbing a given number of steps,
determining whether the best power has changed, and if so, discarding the lowest power point in favor of the new point,
taking a poisedness step to ensure the modified set of highest power points can be fit to a quadratic equation, and
producing the point from the suitable number of points of sufficient power.

7. The method of claim 1, wherein the assembly is one of an optical cross-connect, wavelength cross-connect, or dynamic gain equalizer.

8. The method of claim 1, wherein the actual signal input to the assembly and the actual signal output from the assembly are optical, microwave, x-ray, sound, or laser signals.

9. A method of training an assembly having at least one input mirror and at least one output mirror, comprising:
directing a signal through the assembly;
measuring at least one of an actual signal input to the assembly and an actual signal output from the assembly as a function of position of the at least one input mirror and the at least one output mirror; and
searching for an improved signal output as a function of position of the at least one input mirror and the at least one output mirror including,
obtaining the shape of a hill representative of at least part of the optical cross-connect,
measuring power at an initial point,
using the shape of a hill representative of at least part of the optical cross-connect to take steps of a given size, to improve the power, and if the power improves, identifying a point of improved power; and
using the point of improved power to maintain a connection between the at least one input mirror and the at least one output mirror the assembly.

10. The method of claim 9, wherein the assembly is one of an optical cross-connect, wavelength cross-connect, or dynamic gain equalizer.

11. The method of claim 9, wherein the actual signal input to the assembly and the actual signal output from the assembly are optical, microwave, x-ray, sound, or laser signals.
